(19) United States
(12) Patent Application Publication
(10) Pub. No.: US 2005/0125665 A1
(43) Pub. Date: Jun. 9, 2005

(54) Method and system for controlling access to content

(76) Inventors: Pim Theo Tuyls, Eindhoven (NL); Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/507,678

(22) PCT Filed: Feb. 19, 2003
(86) PCT No.: PCT/IB03/00682

(30) Foreign Application Priority Data
Mar. 18, 2002 (EP) 02076070.8

(51) Int. Cl. H04L 9/00

(52) U.S. Cl. 713/170

(57) ABSTRACT

The invention relates to a method and an access control system for controlling access to content, said content being encrypted by content keys (F1, F2) stored in a key-locker (5) encrypted by a key-locker key (KLK). In order to restore the security of the access control system by updating a PC application or a computer (2) running the PC application without the need for updating a device (3) using said content, a method is proposed comprising the steps of:—defining at least two access keys (K1, K2) and one string (x) by a cryptographic unit (1),—encrypting said string (x) by said cryptographic unit (1) using said access keys (K1, K2) obtaining at least two cryptographic values (h, E),—storing said cryptographic values (h, E) on a computer (2) adapted for accessing said content, enabling said computer (2) to calculate said key-locker key (KLK),—storing said access keys (K1, K2) on a device (3) adapted for accessing said content and transmitting at least one of said cryptographic values (E) either from said computer (2) or from said cryptographic unit (1) to said device (3), enabling said device (3) to calculate said key-locker key (KLK).

The invention relates to a method of controlling access to content, said content being encrypted by content keys stored in a key-locker encrypted by a key-locker key (KLK). The invention relates further to a corresponding access control system, to a cryptographic unit, a computer and a device for use in such an access control system. Still further, the invention relates to a computer program.

The internet is widely regarded to become one of the most important means for distributing digital music. Despite the many advantages, such as greatly reduced distribution costs and availability of a much larger catalogue, there are still a number of disadvantages which need to be solved. The lack of copy protection is a major issue preventing the major record labels to enter this area. It is intended to start a special (subscription based) service for downloading protected music. A special PC application is issued to download encrypted files, such as MP3 files, and store them onto a recordable information carrier, such as a CD-R disc using a common PC-based CD or DVD recorder. The encrypted files can be played on the PC as well as on common or slightly adapted devices, e.g. portable MP3-CD players. The keys of the encrypted files are stored in a so-called key locker, which is an area on the disc that is set aside for that purpose. The key locker itself is encrypted with a key, the so-called key-locker key that is derived from a system-wide secret and, usually, a unique disc identifier. It should be noted that the use of a global secret is required in order to ensure that a disc can be played on any device adapted for this use.

Since the above described PC application can play the encrypted files, it has access to the key-locker key. Therefore, it has also access to the global secret. From a security point of view this is a weakness, because it is well-known that PC software is relatively easily hacked. Thus, it is expected that the global secret will be compromised on a short time scale. Replacing a PC application with an updated one to repair a security breach is relatively easy. However, replacing a hardware device such as a portable MP3-CD player is impossible.

It is therefore an object of the present invention to provide a method, which allows recovery from a security breach by replacing the PC application without having to change the hardware of the device. It is a further object of the invention to provide an access control system and devices for use in such a system as well as a computer program.

This object is achieved by a method of controlling access to content as claimed in claim 1, said method comprising the steps of:
defining at least two access keys and one string by a cryptographic unit,
encrypting said string by said cryptographic unit using said access keys obtaining at least two cryptographic values,
storing said cryptographic values on a computer adapted for accessing said content, enabling said computer to calculate said key-locker key,
storing said access keys on a device adapted for accessing said content and transmitting at least one of said cryptographic values either from said computer or from said cryptographic unit to said device, enabling said device to calculate said key-locker key.

The invention is based on the idea that the device should make use of different secrets than the computer. Since it is relatively easy to hack a computer, it must be prevented that the keys used by the device are lost or compromised when the computer is hacked. This is avoided according to the present invention by generating cryptographic values of a string defined by a cryptographic unit, e.g. a trusted third party such as the manufacturer of devices, the service provider or the content provider, using access keys also defined by said cryptographic unit and by only providing said cryptographic values to the computer but not said access keys and said string. These access keys are only provided to the device, which can not be hacked easily since all functions are usually embedded in hardware therein. The access keys, the string and the cryptographic functions for generating the cryptographic values are chosen such that it is easy to compute the key-locker key if the string is known, but that it is difficult or almost impossible to compute the access keys if the string is unknown even if the cryptographic values are known.

In this way, the string plays the role of a trapdoor. When the computer has been broken but the access keys of the device are still unknown an update of the access control system is possible by replacing the PC application running on the computer or by providing the computer with new cryptographic values generated by use of a differently chosen string. In this way, it is not necessary to update the device with new keys, but it is merely required to provide the device with one of said cryptographic values which can be done via the computer.

It should be noted that the term encrypting does include any ways of encryption such as the use of private and public key pairs or of (collusion-resistant) one-way hash functions.

Preferred embodiments of the invention are defined in the dependent claims. An access control system, preferably for implementing the method as claimed in claim 1, comprising a cryptographic unit, a computer and a device is defined in claim 9. The invention relates further to a cryptographic unit, to a computer and to a device for use in such an access control system as defined in claims 10 to 12. A computer program according to the invention comprising computer program code means for causing a computer to carry out the steps of the method as claimed in claim 1 when said computer program is run on one or more elements of an access control system as claimed in claim 9 is defined in claim 13.

According to a preferred embodiment the content and the key-locker are stored on an information carrier, in particular an optical disc such as a CD or DVD, and the key-locker key is derived from a unique carrier identifier of said information carrier and one of said cryptographic values. Preferably, the cryptographic value used for calculating the key-locker key is not stored on or provided to the device, but said cryptographic value is generated by the device by use of the at least two access keys and the other cryptographic value.

It is further preferred, based on the previous embodiment, that the carrier identifier is read from the information carrier by said computer when accessing said information carrier and that the carrier identifier is either transmitted to the device from the computer or is read by the device from the information carrier when accessing it. Thus it is possible, that the device either directly accesses the information carrier, e.g. plays a disc on which content downloaded from the internet is stored, or that only the computer accesses the information carrier, reads the unique carrier identifier and transmits the content together with the carrier identifier and the required cryptographic value to the device which then plays the content at any time later after reconstructing the key-locker key required for obtaining the content keys for accessing the content.

In a further aspect of the invention the content comprises data files, such as MP3 files, which are each encrypted by different content keys, said content keys being stored in said key-locker. Further, said data files are transmitted from the computer to the device together with the cryptographic value. It should be noted that “content” does not only mean audio data, but may also include any other kind of data such as image, video or software data that may be played back or used on any device. Similarly, the term “device” is not restricted to an audio playback device such as a portable MP3-CD player but may also include any other device for playing back or using any kind of data, such as a video camera, a photo camera, a handheld computer or a portable game device.

Preferably, the key-locker key is calculated by the device using the access keys and the received cryptographic value. In a first step the string defined by the cryptographic unit is reconstructed using the received cryptographic value, and, preferably, one of said access keys. In a second step the result, i.e. the reconstructed string is encrypted using the second access key to obtain the other cryptographic value which is required for calculating the key-locker key. It is thus not necessary that the device receives all the cryptographic values provided to the computer, but one of said cryptographic values is sufficient.

According to another embodiment of the invention the cryptographic unit defines a first, variable string and a second, fixed string which is also stored on the device. One of the at least two cryptographic values is then obtained by encrypting only the first string while a second cryptographic value is obtained by encrypting a combination of said first and second string, e.g. the result of a modulo-2-addition of said two strings. This even more improves security of the overall access control system since, even if the cryptographic values get lost by a hack of the computer, less information on the access keys and the first, variable string gets lost. Thus, the use of the extra second string makes the access control system more secure against adversaries having more ciphertext at their disposal.

In order to even more improve security of the access control system in a further embodiment the second string comprises a first, variable string portion and a second, fixed string portion. In this embodiment the first string portion is transmitted to the device either directly from the cryptographic unit or via the computer, while the second string portion is stored on the device already from the beginning together with the access keys. Thus, at an update the cryptographic unit only chooses a new first string and a new first string portion of the second string. This leads to a new second string and consequently to new cryptographic keys. The fact that the second string can also be changed each time the computer or the application running thereon is updated, introduces more randomness in the plain texts so that therefore less information can be obtained from the cryptographic values.

As already mentioned, it is preferred that the cryptographic values stored on the computer are updated when they have been tampered with. Alternatively or in addition, they may also be updated regularly to improve security of the access control system.

The invention will now be explained in more detail with reference to the drawings, in which:

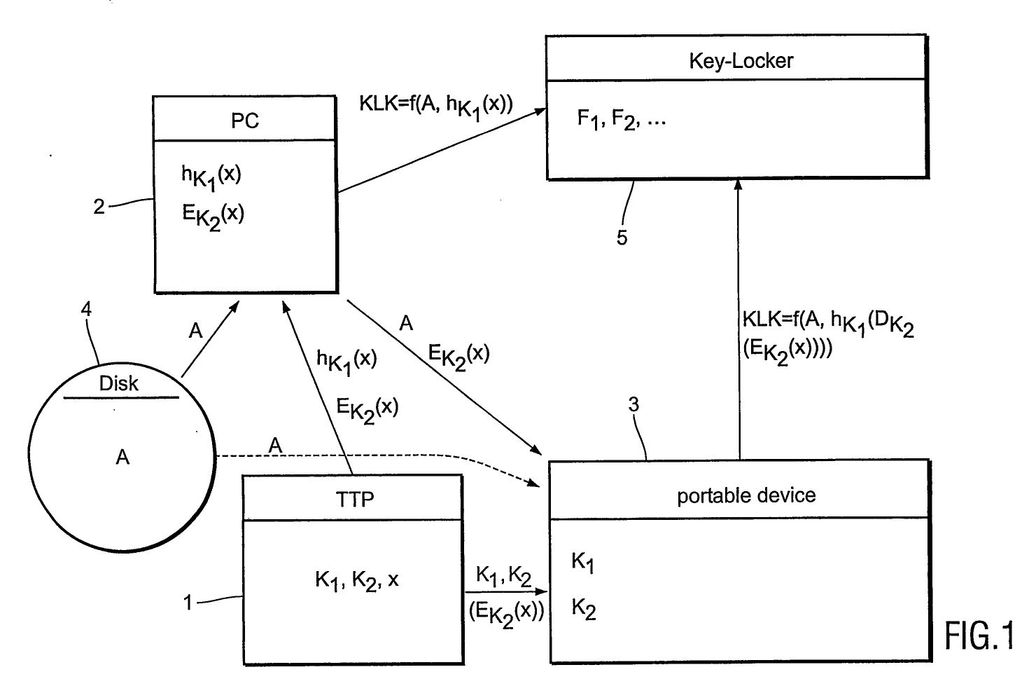

FIG. 1 shows a block diagram of a first embodiment of an access control according to the invention,

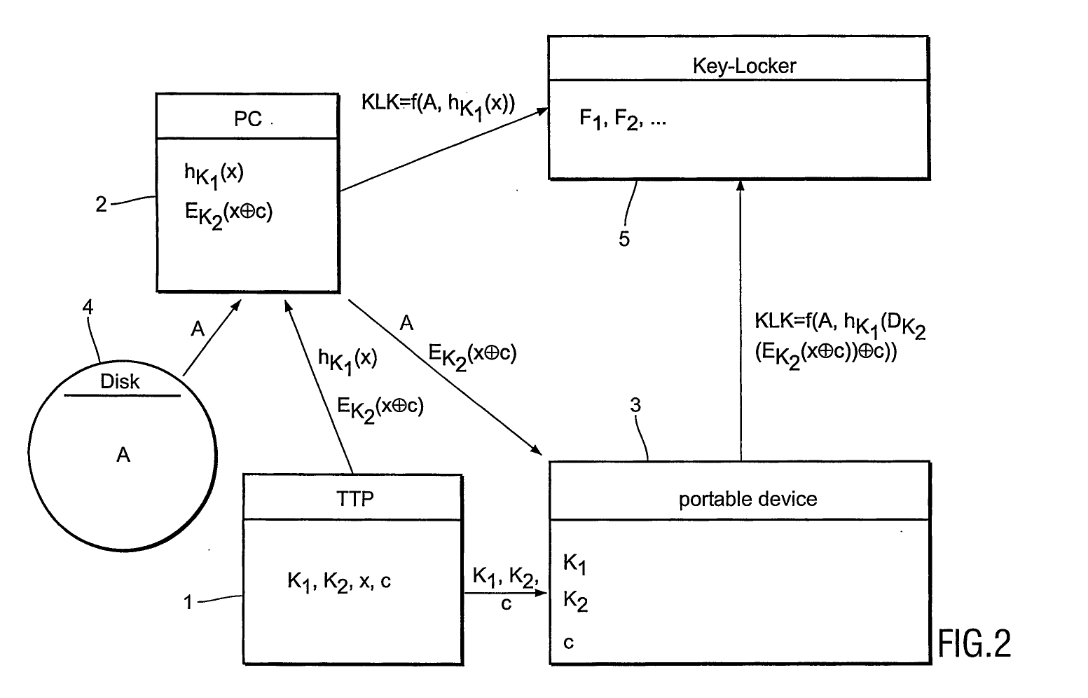

FIG. 2 shows a block diagram of a second embodiment of an access control system according to the invention and

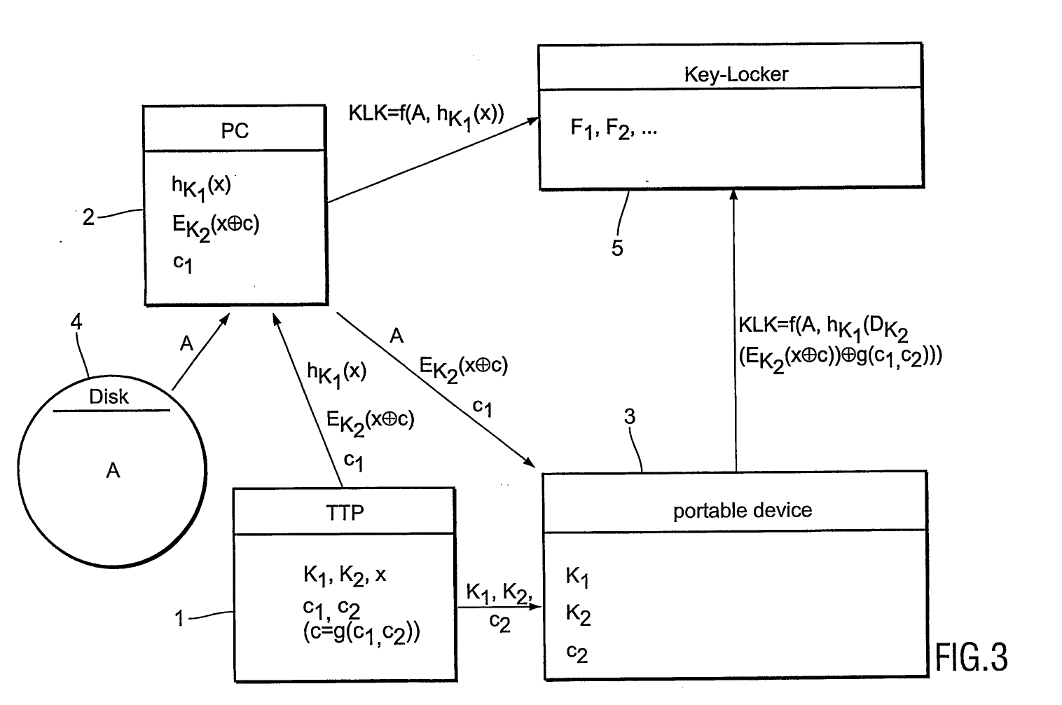

FIG. 3 shows a block diagram of a third embodiment of an access control system according to the invention.

The access control system according to the present invention as shown in FIG. 1 comprises a cryptographic unit 1, such as a trusted third party (TTP), a computer 2, such as a personal computer (PC), a device 3, such as a portable CD player, a MP3-CD player, e.g. a modified version of the Philips eXpanium, or a DVD player, and an information carrier 4, such as a recordable or rewritable disc such as a CD or DVD, a solid state flash card or a removable hard disc, on which in a certain area or in a certain way a key-locker 5 is stored. The information carrier 4 further contains a unique identifier and possibly other data that has to be given to the computer 2. The total set of this data will be denoted by the symbol A. The information carrier 4 is preferably of a recordable or rewritable type so that any kind of data such as audio, video or software data downloaded by the computer 2, e.g. from a server over the internet, can be stored thereon.

The cryptographic unit 1 chooses randomly a string xεZ₂^{m} and two access keys K₁, K₂εZ₂^{k} at random. The computer 2 and the PC application running thereon then carry the following data: a secret cryptographic value h_{K1}(x)εZ₂¹ with 1≦m and a preferably secret cryptographic value E_{K2}(x)εZ₂^{m}. The function h can be a one-way function or the encryption function E, i.e. they are preferably different. Both cryptographic values h_{K1}(x) and E_{K2}(x) are generated by the cryptographic unit 1 and transmitted to the computer 2 for storage thereon.

The device 3 instead does not receive the cryptographic values h_{K1}(x) and E_{K2}(x), but the keys K₁ and K₂ used for generating the cryptographic values h_{K1}(X), E_{K2}(x), i.e. the access keys K₁, K₂ are the keys of the encryption functions h_{K1} and E_{K2} used for encrypting the defined string x resulting in the cryptographic values h_{K1}(x) and E_{K2}(x).

The key-locker key KLK is calculated by the computer 2 as: KLK=f (A, h_{K1} (x)). The function f is chosen such that when the data A, KLK and f itself are known, it is still difficult to derive the cryptographic value h_{K1} (x). It is therefore recommended to choose a one-way or encryption function for f.

After downloading data from the internet this data can be either stored on the disc 4 and/or transmitted, e.g. by disc 4, to the device 3 for use at any place, e.g. MP3 files containing music can be stored on a portable MP3 player. In order to access said files the device 3 needs, at first to access the key-locker to get content keys F₁, F₂ etc. for decrypting these files. In order to access the key-locker 5 a key-locker key KLK is required which can be computed by the device as follows: KLK=f(A,h_{K1}(D_{K2}(E_{K2}(x)))). Therein D_{K2} is the decryption function corresponding to the encryption function E_{K2}. By decrypting the cryptographic value E_{K2}(x) the string x will be obtained on which the encryption function h_{K1} will then be applied. The function f is identical to the function f applied by the computer 2. The necessary data set A will be either received from the disc 4 directly or, preferably, via the computer 2, from which further the cryptographic value E_{K2}(x) is received, preferably via a covert channel. However, the cryptographic value E_{K2}(x) can also be received from a cryptographic unit 1 directly together with the access keys K₁, K₂.

The string x thus plays the role of a trapdoor. It is easy to choose x at random. If x is known it is easy to compute the key-locker key KLK, but when x is unknown then it is unfeasibly difficult to compute the key K₁ even if the cryptographic values h_{K1} (x) and E_{K2} (x) are known. When the computer 2 or the PC application thereon has been broken but the secret keys K₁, K₂ are still unknown, the access control system can easily be updated by replacing the PC application based on one with differently chosen data x or by providing a new string x to the computer 2, i.e. the cryptographic unit 1 chooses a new string x, calculates the cryptographic values h_{K1}(x), E_{K2}(x) and provides them to the computer 2. Thus, it is not necessary to provide any new data from the cryptographic unit 1 to the device 3, which only needs to receive the new cryptographic value E_{K2}(x) from the computer 2.

It can be shown that when the cryptographic value E_{K2}(x) is known, for instance intercepted during transfer from the computer 2 towards the device 3, no information on the access key K₂ has leaked. It can further be shown that even when the computer 2 is broken so that both cryptographic values h_{K1}(x) and E_{K2}(x) are known, only half of the information on the access keys K₁, K₂ has leaked (from an information theoretical point of view).

FIG. 2 shows a block diagram of an improved embodiment of an access control system according to the present invention. The system comprises the same components as the system as shown in FIG. 1. The difference consists in the fact that the cryptographic unit 1 also chooses at random a fixed string cεZ₂^{m}. The computer 2 then contains the following cryptographic values h_{K1}(x) and E_{K2}(x⊕c). The device then gets this fixed string as one extra secret. Again, the computer 2 computes the key-locker key KLK as described above with reference to FIG. 1. However, the device 3 computes the key-locker key KLK differently according to the following relation: KLK=f(A,h_{K1}(D_{K2}(E_{K2}(x⊕c))⊕c)). To enable this computation the device 3 has to be provided with the cryptographic value E_{K2}(x⊕c) from the computer 2 or, alternatively, from the cryptographic unit 1.

Compared to the system as shown in FIG. 1, less information on the access keys K₁, K₂ and the string c will leak through by revealing the cryptographic values h_{K1}(x) and E_{K2}(x⊕c). This makes the access control system more secure against adversaries having more ciphertext at their disposal.

Still another embodiment of an access control system according to the present invention is shown in FIG. 3. The difference with respect to the system as shown in FIG. 2 consists in the fact that the parameter c is not fixed anymore but that it can be changed any time the PC application or the computer 2 is updated. Therefore a function g is defined as follows: g:Z₂^{m}×Z₂^{m}: (c₁, c₂)->c≡g(c₁, c₂).

This function g is chosen according to the constrains of the specific application. The parameters c, c₁ and c₂ do not necessarily have the same bit lengths. One of the two parameters, in particular string portion c₂ which replaces the string c of the embodiment as shown in FIG. 2, is then stored on the device 3 and hence is fixed. By changing the variable string portion c₁ the complete string c is changed. At an update the cryptographic unit 1 will choose a new string portion c₁ and compute the string c=g (c₁, c₂). On the computer 2 then the data h_{K1}(x), c₁ and E_{K2}(x⊕c) are stored. The computer 2 computes the key-locker key KLK again as described above, while the device 3 can compute the key-locker key KLK according to the following relation: KLK=f(A, h_{K1}(D_{K2}(E_{K2}(x⊕c))⊕g(c₁, c₂))). The function is known only to the device and thus cannot be compromised by hacking the PC application. Every time when the PC application or the computer 2 is updated, the cryptographic unit 1 chooses different strings x, c₁. This leads to a new string c and consequently to new cryptographic values h_{K1} (x) and E_{K2} (x⊕c). The fact that the string c can also be changed each time the PC application or the computer 2 is updated, introduces more randomness in the plaintexts x and x⊕c. Therefore less information can be obtained from the ciphertexts h_{K1} (x), E_{K2} (x⊕c).

According to the access control system as shown in FIG. 1 only the plaintext x can be randomly chosen. It can be shown that 4k bits of ciphertext have to be revealed before all information on the access keys K₁, K₂ is revealed (from an information theoretical point of view). This happens after the PC application of the computer 2 has been broken two times, if the key length is of the same order as the ciphertext length. Thus, it is more advantageous to use access keys K₁, K₂ whose length is greater than that of the cryptographic values h, E in order to increase the unicity distance. It should be noted that this does not mean that the access control system is practically broken since it can still be computationally infeasible to find the access keys K₁, K₂ which will be the case for a good encryption function E_{K}.

According to the embodiment as shown in FIG. 2 the strings x and c can be randomly chosen only in the beginning. It can be shown that therein after three updates, provided the key length is comparable to that of the cryptographic values, enough information is available to determine in principle the access keys K₁, K₂. Again for the same reason as above, it is more advantageous to use access keys that are longer than the cryptographic values. However, for good encryption functions h_{K1}, E_{K2} this will still be computationally infeasible.

Finally, according to the embodiment as shown in FIG. 3 a new string x and string portion c₁ can be chosen at every update. It can then be shown that the uncertainty about the access keys K₁, K₂ and the string portion c₂ is independent of the number of ciphertexts that are known. The security level of this system thus becomes much higher as the security level of the systems as shown before.

It should be remarked that in the same way as the parameter c can be changed, also the access keys K₁ and K₂ can be changed. Additional functions have to be defined in order to make this possible.

1. Method of controlling access to content, said content being encrypted by content keys stored in a key-locker encrypted by a key-locker key,
said method comprising the steps of:
defining at least two access keys and one string by a cryptographic unit,
encrypting said string by said cryptographic unit using said access keys obtaining at least two cryptographic values,
storing said cryptographic values on a computer adapted for accessing said content, enabling said computer to calculate said key-locker key,
storing said access keys on a device adapted for accessing said content and transmitting at least one of said cryptographic values either from said computer or from said cryptographic unit to said device, enabling said device to calculate said key-locker key.

2. Method as claimed in claim 1,
wherein said content and said key-locker are stored on an information carrier, in particular an optical disk such as a CD or DVD, and wherein said key-locker key is derived from a unique carrier identifier of said information carrier and one of said cryptographic values.

3. Method as claimed in claim 2,
wherein said carrier identifier is read from said information carrier by said computer when accessing said information carrier and
wherein said carrier identifier is either transmitted to said device from said computer or is read by said device from said information carrier when accessing said information carrier.

4. Method as claimed in claim 1,
wherein said content comprises data files, such as MP3 files, which are each encrypted by a different content key, said content keys being stored in said key-locker, and wherein said data files are transmitted from said computer to said device together with said cryptographic value.

5. Method as claimed in claim 1,
wherein said key-locker key is calculated by said device using said access keys and said received cryptographic value by first reconstructing said string by decrypting said received cryptographic value and then encrypting said reconstructed string to obtain said other cryptographic value.

6. Method as claimed in claim 1,
wherein said cryptographic unit defines a first, variable string and a second, fixed string, which is also stored on said device, and
wherein one of said at least two cryptographic values is obtained by encrypting only said first string and one of said at least two cryptographic values is obtained by encrypting a combination of said first and second string.

7. Method as claimed in claim 6,
wherein said second string comprises a first, variable string portion and a second, fixed string portion,
wherein said first string portion is transmitted to said device either directly from said cryptographic unit or via said computer and
wherein said second string portion is stored on said device.

8. Method as claimed in claim 1,
wherein said string is updated either regularly or when the cryptographic values stored on said computer have been tampered with.

9. Access control system for controlling access to content, said content being encrypted by content keys stored in a key-locker encrypted by a key-locker key,
said system comprising:
a cryptographic unit for defining at least two access keys and one string and for encrypting said string using said access keys obtaining at least two cryptographic values,
a computer, being adapted for accessing said content, for storing said cryptographic values, enabling said computer to calculate said key-locker key,
a device, being adapted for accessing said content, for storing said access keys and for receiving at least one of said cryptographic values either from said computer or from said cryptographic unit, enabling said device to calculate said key-locker key.

10. Cryptographic unit for use in an access control system for controlling access to content, said content being encrypted by content keys stored in a key-locker encrypted by a key-locker key,
said cryptographic unit being adapted for defining at least two access keys and one string and for encrypting said string using said access keys obtaining at least two cryptographic values,
wherein said cryptographic values are stored on a computer adapted for accessing said content, enabling said computer to calculate said key-locker key,
wherein said access keys are stored on a device adapted for accessing said content and
wherein at least one of said cryptographic values is transmitted either from said computer or from said cryptographic unit to said device, enabling said device to calculate said key-locker key.

11. Computer for use in an access control system for controlling access to content, said content being encrypted by content keys stored in a key-locker encrypted by a key-locker key,
wherein at least two access keys and one string are defined and said string is encrypted using said access keys by a cryptographic unit obtaining at least two cryptographic values, the computer being adapted for accessing said content and for storing said cryptographic values, enabling said computer to calculate said key-locker key,
wherein said access keys are stored on a device adapted for accessing said content and wherein at least one of said cryptographic values is transmitted either from said computer or from said cryptographic unit to said device, enabling said device to calculate said key-locker key.

12. A device for use in an access control system for controlling access to content, said content being encrypted by content keys stored in a key-locker encrypted by a key-locker key,
wherein at least two access keys and one string are defined and said string is encrypted using said access keys by a cryptographic unit obtaining at least two cryptographic values,
wherein said cryptographic values are stored on a computer adapted for accessing said content, enabling said computer to calculate said key-locker key,
the device being adapted for accessing said content, for storing said access keys and for receiving least one of said cryptographic values either from said computer or from said cryptographic unit, enabling said device to calculate said key-locker key.

13. Computer program comprising computer program code means for causing a computer to carry out the steps of the method as claimed in claim 1 when said computer program is run on one or more elements of an access control system as claimed in claim 9.
